(19) United States
(12) Patent Application Publication
(10) Pub. No.: US 2025/0347631 A1
(43) Pub. Date: Nov. 13, 2025

(54) OPTICAL DEVICE AND AUTONOMOUS CLEANER

(71) Applicant: PixArt Imaging Inc., Hsin-Chu City (TW)

(72) Inventor: Guo-Zhen Wang, Hsin-Chu City (TW)

(73) Assignee: PixArt Imaging Inc., Hsin-Chu City (TW)

(21) Appl. No.: 19/181,297

(22) Filed: Apr. 16, 2025

Related U.S. Application Data
(63) Continuation of application No. 18/202,944, filed on May 28, 2023.
Application No. 18/202,944 is a division of application No. 17/393,424, filed on Aug. 4, 2021, now Pat. No. 11,703,458.
(60) Provisional application No. 63/121,969, filed on Dec. 6, 2020.

(51) Int. Cl. G01N 21/94; B25J 9/16; B25J 11/00; G01N 21/88

(52) U.S. Cl. CPC G01N 21/94; B25J 9/1697; B25J 11/0085; G01N 21/8806

(57) ABSTRACT

An optical device, comprising: a first light source, configured to emit first light; a second light source, configured to emit second light, wherein the first light and the second light have different light wave lengths; a first image sensing region, configured to sense a first image generated according to the first light; a second image sensing region, configured to sense a second image generated according to the second light; and a processing circuit, configured to determine a condition of a pre-determined region of the optical device according to the first image and the second image. In one embodiment, the optical device is an autonomous cleaner and the processing circuit controls the autonomous cleaner to act corresponding to the condition.

### CROSS REFERENCE TO RELATED APPLICATIONS

This application is a continuation-in-part of U.S. application Ser. No. 18/202,944, filed on May 28, 2023, which is a division of U.S. application Ser. No. 17/393,424, filed on Aug. 4, 2021, which claims the benefit of U.S. Provisional Application No. 63/121,969, filed on Dec. 6, 2020. The contents of these applications are incorporated herein by reference.

### BACKGROUND OF THE INVENTION

### 1. Field of the Invention

The present invention relates to an optical device and an autonomous cleaner, and particularly relates to an optical device and an autonomous cleaner which can avoid hitting obstacles and can determine a liquid type.

### 2. Description of the Prior Art

In recent years, an autonomous cleaner such as a robot cleaner becomes more and more popular. A conventional autonomous cleaner always uses IR (infrared) light to detect an obstacle. After detecting an obstacle, the autonomous cleaner can take corresponding actions, such as avoiding or stopping. However, the IR light can totally pass through a transparent obstacle such as a glass, thus the transparent obstacle could not be detected by the autonomous cleaner. In such case, the autonomous cleaner may directly hit the transparent obstacle.

Besides, while the autonomous cleaner is cleaning a floor, there may be some liquid on the floor. Some autonomous cleaners have the function of removing liquids, but not every liquid is suitable for autonomous cleaner to clean. For example, when the liquid is animal urine, if the autonomous cleaner cleans it, it may contaminate the entire machine.

Therefore, the autonomous cleaner needs some new mechanisms to improve the above-mentioned issue.

### SUMMARY OF THE INVENTION

One objective of the present invention is to provide an optical device which can detect transparent material or translucent material.

Another objective of the present invention is to provide an optical device which can detect transparent material or translucent material.

One embodiment of the present invention is to provide an optical device, comprising: a first light source, configured to emit first light; a second light source, configured to emit second light, wherein the first light and the second light have different light wave lengths; a first image sensing region, configured to sense a first image generated according to the first light; a second image sensing region, configured to sense a second image generated according to the second light; and a processing circuit, configured to determine a condition of a pre-determined region of the optical device according to the first image and the second image.

Another embodiment of the present invention is to provide an autonomous cleaner, comprising: a first light source, configured to emit first light; a second light source, configured to emit second light, wherein the first light and the second light have different light wave lengths; a first image sensing region, configured to sense a first image generated according to the first light; a second image sensing region, configured to sense a second image generated according to the second light; and a processing circuit, configured to determine a condition of a pre-determined region of the optical device according to the first image and the second image, and controls the autonomous cleaner to act corresponding to the condition.

In view of above-mentioned embodiments, the object condition or the liquid type can be determined by using different types of light, thus the issue of a conventional autonomous cleaner can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a structure of an autonomous cleaner, according to one embodiment of the present invention.

FIG. 2 is a schematic diagram illustrating the structures of the image sensor in FIG. 1, according to one embodiment of the present embodiment.

FIG. 3 is a schematic diagram illustrating the actions of the autonomous cleaner in FIG. 1, according to one embodiment of the present invention.

FIG. 4 is a schematic diagram illustrating a structure of an autonomous cleaner, according to another embodiment of the present invention.

FIG. 5 is a schematic diagram illustrating a structure of an autonomous cleaner, according to another embodiment of the present invention.

FIG. 6 is a schematic diagram illustrating the actions of the autonomous cleaner in FIG. 5, according to one embodiment of the present invention.

FIG. 7, FIG. 8 and FIG. 9 are schematic diagrams illustrating the actions of the autonomous cleaner, according to embodiments of the present invention.

### DETAILED DESCRIPTION

In the following descriptions, several embodiments are provided to explain the concept of the present application. The terms “first”, “second”, “third” in following descriptions are only for the purpose of distinguishing different one elements, and do not mean the sequence of the elements. For example, a first device and a second device only mean these devices can have the same structure but are different devices.

Detail structures of an autonomous cleaner and actions thereof are stated in following descriptions. Please note, the structures disclosed in following embodiments can be applied to any other optical device rather than limited to an autonomous cleaner.

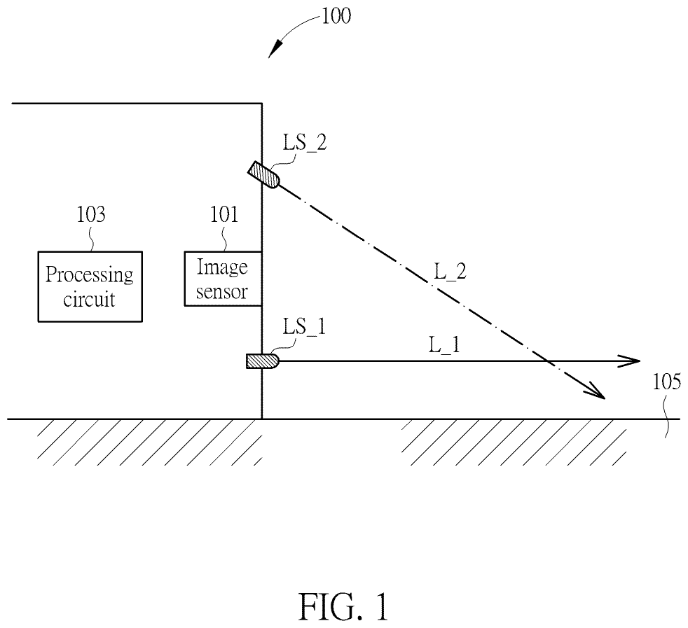

FIG. 1 is a schematic diagram illustrating a structure of an autonomous cleaner, according to one embodiment of the present invention. As shown in FIG. 1, the autonomous cleaner 100 comprises a first light source LS_1, a second light source LS_2, an image sensor 101 and a processing circuit 103. The first light source LS_1 is configured to emit first light L_1. Also, the second light source LS_2 is configured to emit second light L_2, wherein the first light L_1 and the second light L_2 have different light wave lengths. The first light L_1 can totally pass through transparent material (e.g., glass or plastic) which is translucent or transparent, and at least portion of the second light L_2 can be reflected by the transparent material. Further, if the second light L_2 is emitted to the liquid, the image of the liquid has fluorescene patterns if the liquid has proteins. In embodiments of FIG. 1-FIG. 6, the first light L_1 is IR light and the second light L_2 is UV (ultraviolet) light. However, light having the same characteristics can be used in the present invention.

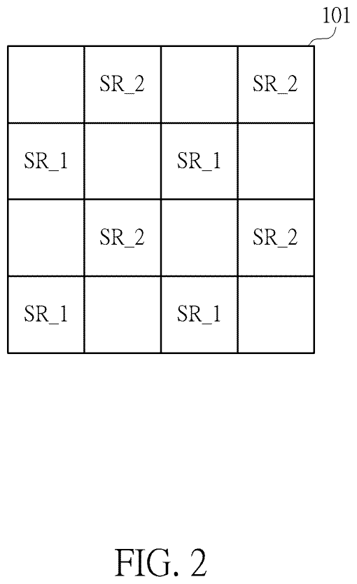

FIG. 2 is a schematic diagram illustrating the structures of the image sensor 101 in FIG. 1, according to one embodiment of the present embodiment. As shown in FIG. 2, the image sensor 101 comprises a plurality of first image sensing regions SR_1 and a plurality of second image sensing regions SR_2. The first image sensing regions SR_1 are configured to sense a first image generated according to the first light L_1. Also, the second image sensing regions SR_2 are configured to sense a second image generated according to the second light L_2. The processing circuit 103 is configured to determine a condition of a pre-determined region of the autonomous cleaner 100 according to the first image and the second image. The condition may be the existence of the object or the type of the liquid. Also, the pre-determined region may mean a region which the image sensor 101 can sense.

In the embodiment of FIG. 2, the first image sensing regions SR_1 and the second image sensing regions SR_2 are different portions of a single image sensor (the image sensor 101). Accordingly, the first image sensing regions SR_1 and the second image sensing regions SR_2 use the same reading circuit to read image data of pixels thereof. Further, a single raw or a single column of the image sensor 101 comprises pixels of the first image sensing regions SR_1 and pixels of the second image sensing regions SR_2. However, the first image sensing regions SR_1 and the second image sensing regions SR_2 can be two different image sensors.

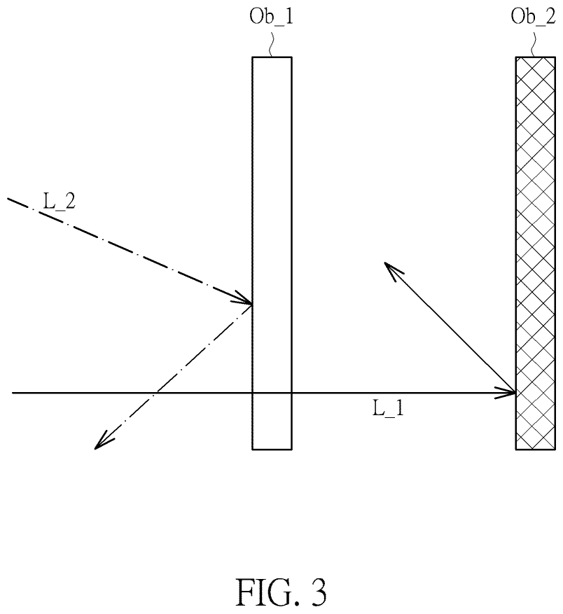

FIG. 3 is a schematic diagram illustrating the actions of the autonomous cleaner in FIG. 1, according to one embodiment of the present invention. In FIG. 3, the object Ob_1 is a transparent object (such as glass or plastic) and the object Ob_2 is a non-transparent object (such as a cement wall). As above-mentioned, the first light L_1 can totally pass through transparent material which is translucent or transparent, and at least portion of the second light L_2 can be reflected by the transparent material. Accordingly, in the embodiment of FIG. 3, the first light L_1 can totally pass through the object Ob_1 and is only reflected by the object Ob_2. Further, in the embodiment of FIG. 3, a portion of the second light L_2 is reflected by the object Ob_1 and a portion of the second light L_2 is absorbed by the object Ob_1.

Accordingly, in the embodiment of FIG. 3, the object Ob_2 can be detected according to the first image generated according to the first light L_1, but the object Ob_1 cannot be detected according to the first image. Besides, the object Ob_1 can be detected according to the second image generated according to the second light L_2. Further, in such embodiment, the first light source LS_1 and the second light source LS_2 can emit light simultaneously or alternately.

After detecting the existence of the object Ob_1 or the object Ob_2, the autonomous cleaner 100 may correspondingly act. For example, the autonomous cleaner 100 detects the existence of the object Ob_2 thus turns or stops before hitting the object Ob_2.

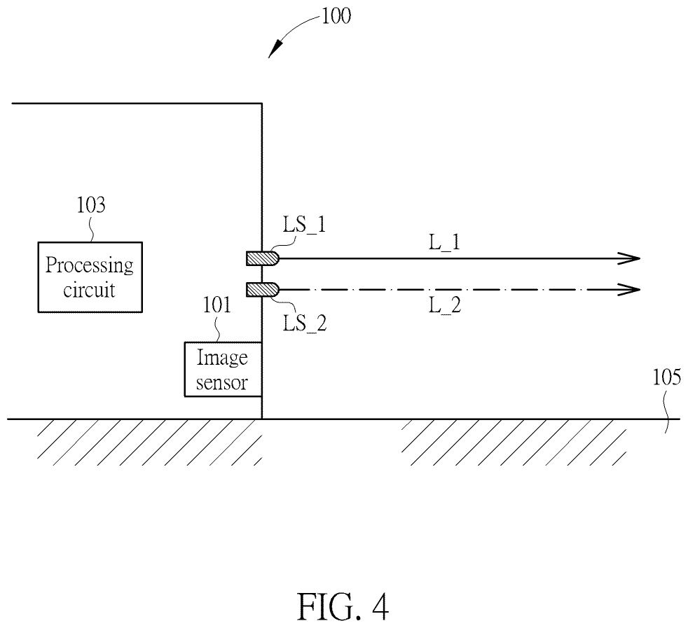

In the embodiment of FIG. 1, the emitting direction of the first light L_1 is parallel with a working surface 105 (e.g., a ground) on which the autonomous cleaner 100 is located. Also, the emitting direction of the second light L_2 is toward the working surface 105. However, the emitting directions of the first light L_1 and the second light L_2 are not limited to such example. For example, in the example of FIG. 4, the emitting directions of the first light L_1 and the second light L_2 are all parallel with the working surface 105. Further, in one embodiment, the emitting direction of the first light L_1 or the second light L_2 is away from the working surface 105. The location of the image sensor 101 can be changed corresponding to the locations of the first light source LS_1 and the second light source LS_2.

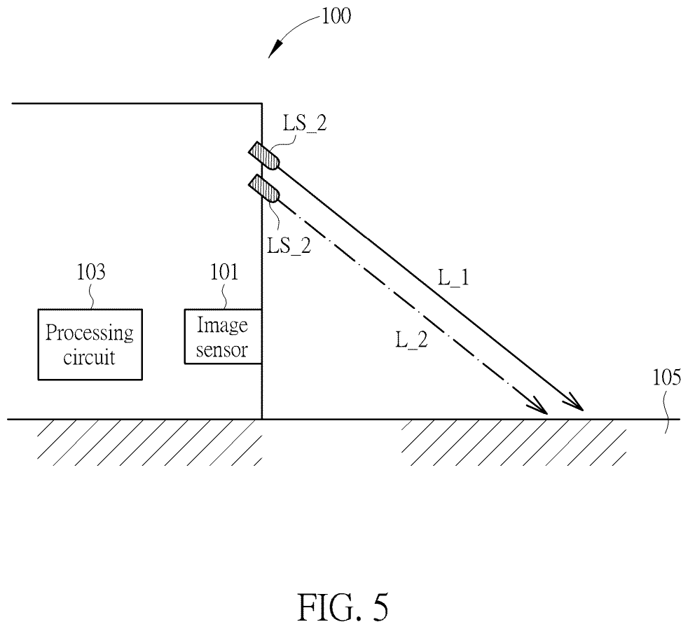

FIG. 5 is a schematic diagram illustrating a structure of an autonomous cleaner, according to another embodiment of the present invention. The autonomous cleaner 100 in FIG. 5 also comprises the first light source LS_1, the second light source LS_2, the image sensor 101 and the processing circuit 103. However, in the embodiment of FIG. 5, the emitting directions of the first light L_1 and the second light L_2 are toward the working surface 105. The embodiment of FIG. 5 can be used to detect a type of the liquid, as stated below.

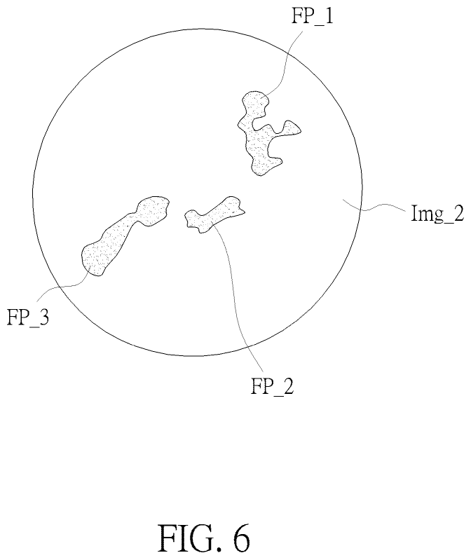

FIG. 6 is a schematic diagram illustrating the actions of the autonomous cleaner in FIG. 5, according to one embodiment of the present invention. As above-mentioned, if the second light L_2 is emitted to the liquid, the image of the liquid emitted by the second light L_2 has fluroscene patterns if the liquid has proteins. Accordingly, in the embodiment of FIG. 6, the second image Img_2 which is generated according to the second light L_2 has fluroscene patterns FP_1, FP_2 and FP_3. Therefore, in this case, the liquid type can be classified to liquid with proteins or liquid without proteins. For example, the liquid type can be classified to milk or non-milk. Please note, the arrangements of the fluroscene patterns are not limited to the fluroscene patterns FP_1, FP_2 and FP_3 shown in FIG. 6, and the liquid type is not limited to be classified to milk or non-milk.

In the embodiments of FIG. 5 and FIG. 6, the first light L_1 can be used to detect the existence of the liquid. For more detail, the image of the liquid may have a higher brightness when the first light L_1 is emitted to the liquid, if the liquid has a high light guiding ability. Accordingly, in one embodiment, the first light source LS_1 initially turns on and the second light source LS_2 initially turns off. If existence of the liquid is detected according to the first image generated according to the first light L_1, the first light source LS_1 turns off and the second light source LS_2 turns on, to determine the liquid type. However, if only the second light L_2 is used to detect the liquid, the emitting direction of the first light L_1 can be away from or be parallel with the working surface 105.

As above-mentioned, the actions of FIG. 5 and FIG. 6 can be used to detect a type of any liquid which contains proteins, such as animal urine, milk or broth. Such liquid may contaminate the autonomous cleaner 100 or make the ground worse if autonomous cleaner 100 tries to clean it. Accordingly, if the autonomous cleaner 100 finds the existence of the liquid with proteins, it may act correspondingly. For example, the autonomous cleaner 100 can avoid the liquid and inform the user to clean it by other methods.

Besides the fluroscene patterns, the liquid type may be determined by other characteristics. In one embodiment, the liquid type may be determined by a light absorbing rate of the liquid. The light absorbing rate means the amount of light which is not reflected and scattered when the light is emitted to the liquid. The higher the light absorbing rate, the more amount of light is not reflected and scattered when the light is emitted to the liquid.

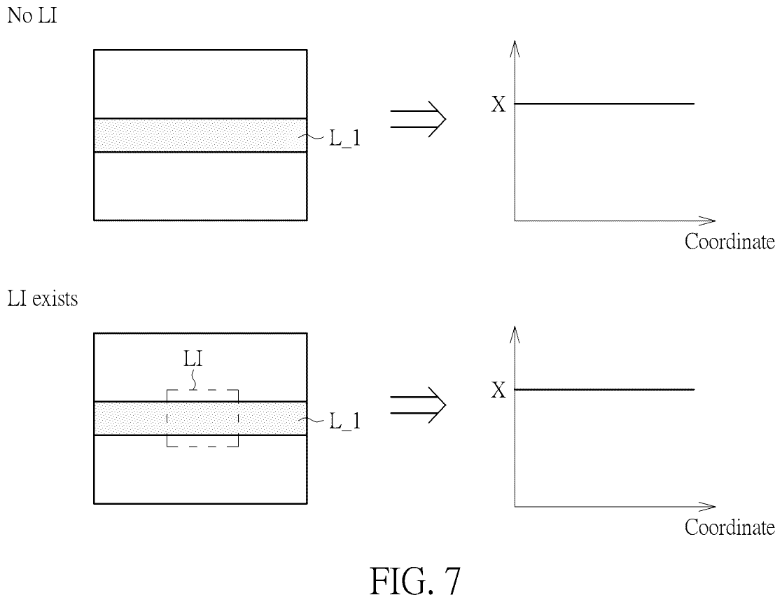

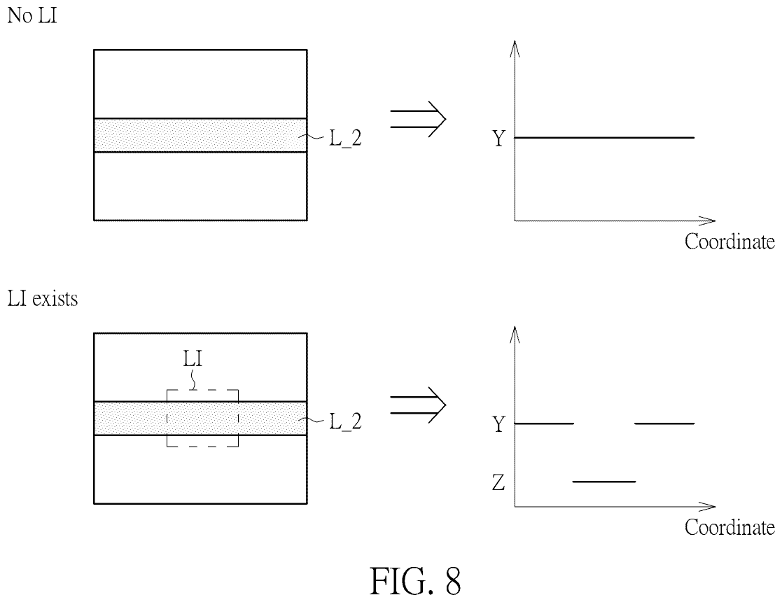

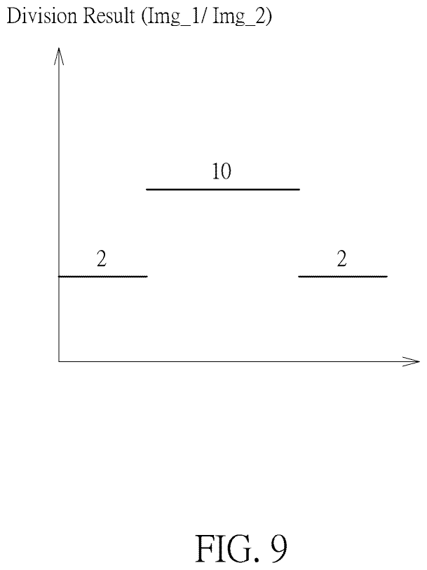

FIG. 7, FIG. 8 and FIG. 9 are schematic diagrams illustrating the actions of the autonomous cleaner, according to embodiments of the present invention. The structure of the embodiment of FIG. 5 can be used to perform the embodiments of FIG. 7, FIG. 8 and FIG. 9. In FIG. 7, the upper left diagram illustrates the first light L_1 is a straight light and no liquid LI exists. Also, the upper right diagram of FIG. 7 illustrates the light intensity of the image of the first light L_1 corresponding to the upper left diagram. Further, in FIG. 7, the bottom left diagram of illustrates the first light L_1 is emitted to the liquid LI. Also, the bottom right diagram of FIG. 7 illustrates the light intensity of the image of the first light L_1 corresponding to the bottom left diagram.

Similarly, In FIG. 8, the upper left diagram illustrates the second light L_2 is a straight light and no liquid LI exists. Also, the upper right diagram of FIG. 8 illustrates the light intensity of the image of the second light L_2 corresponding to the upper left diagram. Further, in FIG. 8, the bottom left diagram illustrates the second light L_2 is emitted to the liquid LI. Also, the bottom right diagram of FIG. 8 illustrates the light intensity of the image of the second light L_2 corresponding to the bottom left diagram.

In these embodiments, the light wave length of the first light L_1 is smaller than the light wave length of the second light L_2. For example, the light wave length of the first light L_1 is 850 nm and the light wave length of the second light L_2 is 1300 nm, but not limited. Besides, in these embodiments, the above-mentioned first image sensing region is a CMOS sensor and the second image sensing region is a SWIR (Short Wavelength InfraRed) sensor or an InGaAs photo detector. In one embodiment, the autonomous cleaner 100 comprise a plurality of InGaAs photo detectors, since the sensing region of the InGaAs photo detector is small.

In the embodiments of FIG. 7, FIG. 8 and FIG. 9, the processing circuit 103 determines whether the liquid is water or not. Also, a first light absorbing rate of the liquid LI to the first light L_1 is lower than a second light absorbing rate of the liquid LI to the second light L_2, but not limited. The concepts disclosed in FIG. 7, FIG. 8 and FIG. 9 can be applied to any other type of liquid. In FIG. 7, as above-mentioned, the first light absorbing rate of the liquid LI to the first light L_1 is low, thus the light intensity of the image of the liquid LI (e.g., the intensity X) emitted by the first light L_1 is identical with the light intensity (e.g., the intensity X) of the image of the first light L_1 which is not emitted to the liquid LI. In other words, the light intensities in the upper right diagram and the lower right diagram of FIG. 7 are the same.

In FIG. 8, as above-mentioned, the second light absorbing rate of the liquid LI to the second light L_2 is high. Accordingly, the light intensity of the image of the liquid LI (e.g., the intensity Z) emitted by the second light L_2 is lower than the light intensity (e.g., the intensity Y) of the image of the second light L_2 which is not emitted to the liquid LI.

As above-mentioned, the first image is generated according to the first light L_1 and the second image is generated according to the second light L_2. Accordingly, the images in the embodiments of FIG. 7 and FIG. 8 can be respectively regarded as the first image and second image. As illustrated in FIG. 7, the light intensity of the image of the first light L_1 in the first image does not vary corresponding to the existence of the liquid LI. Further, as illustrated in FIG. 8, the light intensity of the image of the second light L_2 in the second image may vary corresponding to the existence of the liquid LI. Accordingly, a division result of the first image and the second image can be used to determine a liquid type of the liquid LI.

FIG. 9 illustrates the division result of the image of a region emitted by the first light L_1 in the first image Img_1 and the image of a region emitted by the second light L_2 in the second image Img_2, when the liquid LI exists. In the example of FIGS. 9, X=200, Y=100, and Z=20. Accordingly, as shown in FIG. 9, the division results from left to right are 2 (i.e., X/Y), 10 (i.e., X/Z), 2 (i.e., X/Y). Therefore, a division result of the first image Img_1 and the second image Img_2 can be used to determine a liquid type of the liquid LI. Specifically, the liquid LI can be determined to be water or not according to whether the variation of the division result meets a specific rule. For example, if a maximum value of the division result and a minimum division result is in a predetermined range, the liquid LI is water, otherwise the liquid LI is another type of liquid. In one embodiment, if the variation of the division result meets a first specific rule, the liquid LI is determined as a first type of liquid. Also, if the variation of the division result meets a second specific rule, the liquid LI is determined as a second type of liquid.

In above-mentioned embodiments, the image of the liquid LI emitted by the first light L_1 and the image of the first light L_1 which is not emitted to the liquid LI have the same light intensities, as shown in the bottom right diagram of FIG. 7. However, these two kinds of the images may have different light intensities. For example, in one embodiment, the image of the liquid LI emitted by the first light L_1 has a first light intensity and the image of the first light L_1 which is not emitted to the liquid LI has a second light intensity. In such case, the image of the liquid LI emitted by the second light L_2 has a third light intensity and the image of the second light L_2 which is not emitted to the liquid LI has a fourth light intensity. By this way, the liquid type can still be determined according to the division result of the first image Img_1 and the second image Img_2, following the rules stated in FIG. 7, FIG. 8 and FIG. 9.

The autonomous cleaner 100 may act corresponding to the determined liquid type. For example, the autonomous cleaner 100 can avoid the liquid and inform the user to clean it by other methods, it the liquid is determined as animal urine. For another example, the autonomous cleaner 100 can directly clean the liquid if the liquid is determined as water.

In view of above-mentioned embodiments, the object condition or the liquid type can be determined by using different types of light, thus the issue of a conventional autonomous cleaner can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical device, comprising:
a first light source, configured to emit first light;
a second light source, configured to emit second light, wherein the first light and the second light have different light wave lengths;
a first image sensing region, configured to sense a first image generated according to the first light;
a second image sensing region, configured to sense a second image generated according to the second light; and
a processing circuit, configured to determine a condition of a pre-determined region of the optical device according to the first image and the second image.

2. The optical device of claim 1, wherein the first light can totally pass transparent material which is translucent or transparent, and the second light can be reflected by the transparent material.

3. The optical device of claim 2, wherein the first light is IR (infrared) light and the second light is UV (ultraviolet) light.

4. The optical device of claim 1, wherein the second image of liquid has fluroscene patterns if the liquid has proteins.

5. The optical device of claim 4, wherein the second light is UV (ultraviolet) light.

6. The optical device of claim 1, wherein the first image sensing region and the second image sensing region are different portions of a single image sensor.

7. The optical device of claim 1, wherein a first light absorbing rate of the liquid to the first light is lower than a second light absorbing rate of the liquid to the second light.

8. The optical device of claim 7, wherein the light wave length of the first light is smaller than the light wave length of the second light.

9. The optical device of claim 7, wherein the first image sensing region is a CMOS sensor and the second image sensing region is a SWIR sensor or an InGaAs photo detector.

10. The optical device of claim 1, wherein the processing circuit determines a liquid type in the predetermined range according to a division result of the first image and the second image.

11. An autonomous cleaner, comprising:
a first light source, configured to emit first light;
a second light source, configured to emit second light, wherein the first light and the second light have different light wave lengths;
a first image sensing region, configured to sense a first image generated according to the first light;
a second image sensing region, configured to sense a second image generated according to the second light; and
a processing circuit, configured to determine a condition of a pre-determined region of the optical device according to the first image and the second image, and controls the autonomous cleaner to act corresponding to the condition.

12. The autonomous cleaner of claim 11, wherein the first light can totally pass transparent material which is translucent or transparent, and the second light can be reflected by the transparent material.

13. The autonomous cleaner of claim 12, wherein the first light is IR (infrared) light and the second light is UV (ultraviolet) light.

14. The autonomous cleaner of claim 11, wherein the second image of liquid has fluroscene patterns if the liquid has proteins.

15. The autonomous cleaner of claim 14, wherein the second light is UV (ultraviolet) light.

16. The autonomous cleaner of claim 11, wherein the first image sensing region and the second image sensing region are different portions of a single image sensor.

17. The autonomous cleaner of claim 11, wherein a first light absorbing rate of the liquid to the first light is lower than a second light absorbing rate of the liquid to the second light.

18. The autonomous cleaner of claim 17, wherein the light wave length of the first light is smaller than the light wave length of the second light.

19. The autonomous cleaner of claim 17, wherein the first image sensing region is a CMOS sensor and the second image sensing region is a SWIR sensor or an InGaAs photo detector.

20. The autonomous cleaner of claim 11, wherein the processing circuit determines a liquid type in the predetermined range according to a division result of the first image and the second image.
